(19) United States
(12) Patent Application Publication
(10) Pub. No.: US 2017/0337103 A1
(43) Pub. Date: Nov. 23, 2017

(54) METHOD AND APPARATUS TO PROVIDE DATA REDUNDANCY IN A SOLID-STATE DRIVE

(71) Applicant: Intel Corporation, Santa Clara, CA (US)

(72) Inventor: Robert J. Royer, JR., Portland, OR (US)

(21) Appl. No.: 15/159,700

(22) Filed: May 19, 2016

(51) Int. Cl. G06F 11/10; G06F 3/06

(52) U.S. Cl. CPC G06F 11/108; G06F 11/1088; G06F 3/0619; G06F 3/0655; G06F 3/0688

(57) ABSTRACT

A solid-state drive may be coupled via an interface with a processing device that receives an indication of a failure of a logical unit of a non-volatile memory of the solid-state drive. In response to the indication of the failure, parity data at locations of other logical units of the non-volatile memory of the solid-state drive may be identified. User data from the logical unit may be reconstructed based on the parity data from the locations of the other logical units of the non-volatile memory of the solid-state drive. Furthermore, the reconstructed user data from the logical unit may be stored at the locations of the other logical units that store the parity data.

### TECHNICAL FIELD

Embodiments described herein generally relate to data redundancy, and more specifically, relate to data redundancy in a solid-state drive.

### BACKGROUND

Various techniques may be used to provide data redundancy. For example, a redundant array of independent disks (RAID) implementation may combine multiple disk drives (e.g., physical storage devices such as Hard Disk Drives (HDDs) and Solid State Drives (SSDs) into a single logical unit to provide data redundancy and improved performance. The HDDs or SSDs may be considered to be part of a single RAID array. The data of the logical unit may be stored or distributed across each of the disks of the RAID array. To provide redundancy for this data stored in the RAID array, parity data stored in the disks may be used by the RAID array. For example, if one of the disks in the RAID array fails, then the remaining data on the other disks may be combined with the parity data to reconstruct the missing data from the failed disk. A Boolean Exclusive OR (XOR) operation may be performed between the data and parity data on the remaining disks to reconstruct the missing data.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example of a computing environment including an example solid-state drive in accordance with some embodiments of the present disclosure.

FIG. 2 is a flow diagram of an example method to overwrite parity data with reconstructed user data of a failed logical unit in accordance with some embodiments.

FIG. 3A illustrates an example of four functional logical units of a solid-state drive in accordance with some embodiments of the present disclosure.

FIG. 3B illustrates an example of the overwriting of parity data with reconstructed user data of one failed logical unit of a solid-state drive in accordance with some embodiments.

FIG. 3C illustrates an example of the four logical units after the overwriting of parity data with reconstructed user data in accordance with some embodiments.

FIG. 4 is a flow diagram of a method to disable die redundancy or to generate a notification of a failed solid-state drive based on a number of failed logical units in accordance with some embodiments of the disclosure.

FIG. 5 illustrates an example table with a layout of user data and parity data in logical units of a solid-state drive in accordance with some embodiments of the disclosure.

FIG. 6 is a block diagram of an example computer system associated with the solid-state drive.

FIG. 7 is a block diagram of another example computer system associated with the solid-state drive.

### DETAILED DESCRIPTION

Aspects of the present disclosure are directed to a die redundancy implementation based on logical units in a solid-state drive. In general, a die redundancy may be implemented within a single solid-state drive based on logical units. The solid-state drive may include a controller and non-volatile memory.

Data redundancy may be provided by the use of parity data and a Boolean exclusive-or (XOR) operation. For example, in a RAID array that is based on multiple distinct disk drives, data may be divided into various blocks that are distributed across the disk drives in the RAID array. The data blocks divided between the disk drives may be referred to as a stripe and each data block of the stripe may be referred to as a strip. As an example, a body of user data (i.e., logically sequential data such as a file corresponding to a stripe) may be distributed as a first user data (i.e., a first strip) that may be stored at a first disk drive of the RAID array, second user data (i.e., a second strip) may be stored at a second disk drive, and third user data (i.e., a third strip) may be stored at a third disk drive. The combination of the first user data, second user data, third user data, and parity data may correspond to a stripe. The parity data for the first, second, and third user data may be generated by performing the XOR operation on the first, second, and third user data. This parity data may be stored at another disk drive of the RAID array. If any of the disk drives that are storing the first, second, or third user data fails and the respective user data is lost as a result of the disk drive failing, then the lost user data may be reconstructed by using the parity data. For example, if the third disk drive fails and the third user data is not recoverable from the third disk drive, then the third user data may be reconstructed by performing an XOR operation between the first user data stored at the first disk drive, the second user data stored at the second disk drive, and the parity data stored at another disk drive of the RAID array. Thus, the user data in the RAID array may be recoverable even if one of the disk drives of the RAID array has failed or is non-functional.

In an embodiment, die redundancy is provided within a SSD using distributed parity data and data striping to store parity data and user data across separate logical units of the non-volatile memory in the SSD. A logical unit may be one or more die of the non-volatile memory. For example, the non-volatile memory to store data in the SSD may be divided into four logical units where data in each logical unit is kept separate from other logical units of the non-volatile memory in the SSD so that neither the user data nor parity data may be moved from one logical unit to another logical unit. Each logical unit of non-volatile memory may store user data as well as parity data. The parity data at one of the logical units of non-volatile memory may be used to reconstruct the user data at another logical unit that has failed. For example, a first logical unit may store parity data for other user data that is stored at the second, third, and fourth logical units of the same SSD. If the user data at one of the second, third, or fourth logical units is irretrievable or corrupted (e.g., through a failure or malfunction of a semiconductor die corresponding to a portion of the failed logical unit), then the user data may be reconstructed by using parity data and the other user data that is stored at the still functional logical units of the SSD. Furthermore, the reconstructed user data may be stored at the locations of each functional logical unit that stores parity data. For example, the reconstructed user data may overwrite the parity data at the other functional logical units. After the overwriting of the parity data, the die redundancy implementation to provide the die redundancy for the SSD may be disabled, but the SSD may remain functional despite a significant die failure corresponding to the failed logical unit as the user data has been reconstructed.

As such, die redundancy may be provided for a single SSD in part by parity data stored across logical units of the SSD. The die redundancy may protect against the failure of one of the logical units of the SSD. As such, the reliability of the user data stored in the non-volatile memory in the SSD may be improved despite if the SSD has been manufactured with a higher die failure rate (e.g., the SSD may remain functional when one or more die of the non-volatile memory fails). Furthermore, the controller of the SSD may not include the functionality to perform an XOR operation to provide some redundancy, and the die redundancy described herein may be used in an SSD with a controller that does not include such functionality. Instead, the die redundancy functionality may be provided by software or hardware that is external to the SSD. For example, the SSD with the controller may transmit an interrupt over an I/O interface (e.g., a Peripheral Component Interconnect Express (PCIe) interface) coupling the SSD with a host computer. The interrupt may be based on a Non-Volatile Memory Express (NVMe) specification. The NVM Express specification defines an optimized register interface, command set and feature set for PCI Express (PCIe®)-based Solid-State Drives (SSDs). For example, in an NVMe embodiment, an asynchronous notification interrupt may be sent from the SSD over the PCIe interface to interrupt a driver associated with the SSD in the host computer using a PCIe interrupt or Message Signaled Interrupts (MSI). In some embodiments, in response to receiving the interrupt, the host computer may access data stored in a log page stored in the non-volatile memory of the SSD. For example, the log page may be stored in dies of the non-volatile memory corresponding to each of the logical units. When a logical unit fails, the log page associated with the remaining functional logical units may be updated to identify that a logical unit has failed and the asynchronous notification interrupt may be issued to the host computer. In response to receiving the asynchronous notification interrupt, the host computer may access a log page stored in one of the logical units to identify whether a logical unit has failed.

Furthermore, the die redundancy based on logical units as described herein may provide for the die redundancy if the controller of the SSD does not include functionality to perform an XOR operation to provide some redundancy in cases where a die of the non-volatile memory of the SSD has failed. However, the implementation of the XOR operation in the controller of the SSD may increase the complexity in the design of the SSD controller. In order to provide redundancy within a single SSD that does not include a controller with functionality to perform an XOR operation, the SSD may be divided into logical units and the redundancy may be provided by software or hardware that is external to SSD and is thus not implemented in the controller of the SSD.

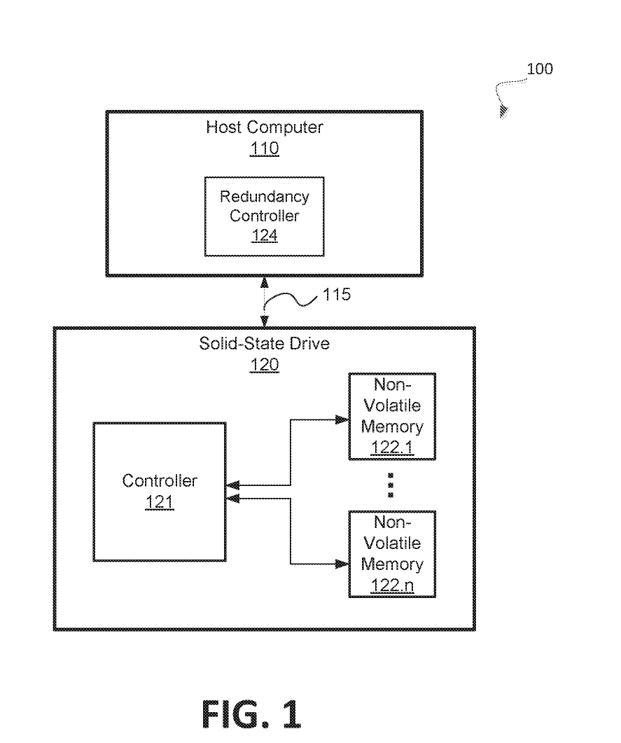

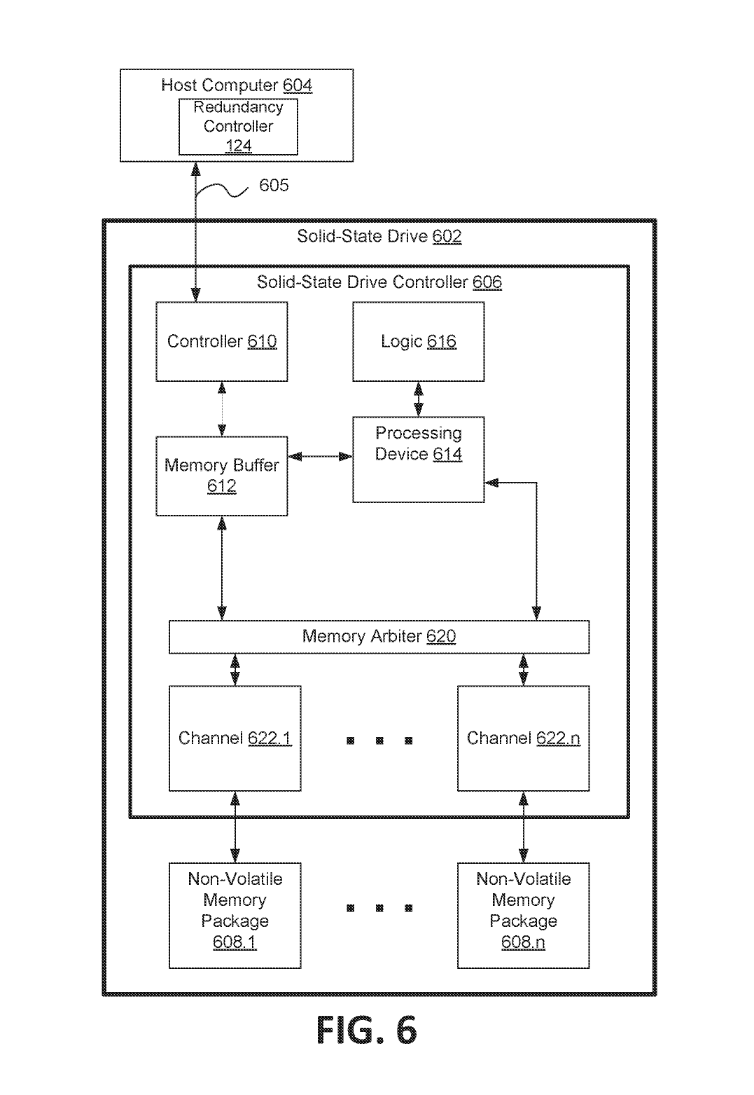

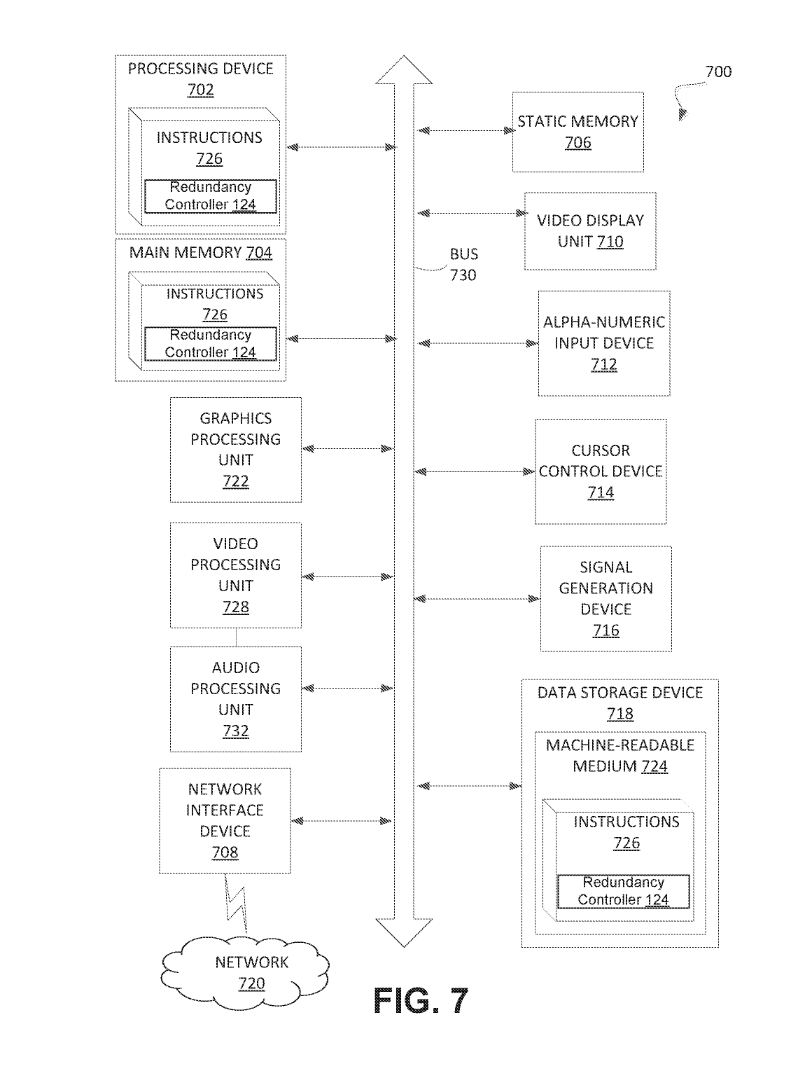

FIG. 1 illustrates an example computing environment 100 including a solid-state drive 120. In general, the computing environment 100 may include a host computer 110 that includes or is coupled to a solid-state drive 120. The host computer 110 may be a type of computing system or computing device that is operatively coupled to the solid-state drive 120. For example, an input/output (I/O) interface 115 may be used to transfer data between the host computer 110 and the solid-state drive 120. The I/O interface 115 may be arranged as a Serial Advanced Technology Attachment (SATA) interface to couple elements of the host computer 110 to the solid-state drive 120. In the same or alternative embodiments, the I/O interface 115 may be arranged as a Serial Attached SCSI (SAS) interface to couple the elements of the host computer 110 to the solid-state drive 120. In some embodiments, the I/O interface 115 may be arranged as a PCIe interface to couple the elements of the host computer 110 with the solid-state drive120. Further details with regard to the host computer 110 are described in conjunction with FIGS. 6-7.

As shown in FIG. 1, the solid-state drive 120 may include a controller 121 (also referred to as an SSD controller) and non-volatile memory 122.1 to 122.n. In some embodiments, non-volatile memory may refer to one of the non-volatile memory packages (e.g., chips or dies) and in other embodiments non-volatile memory may refer to multiple non-volatile memory packages. The controller 121 may manage data stored at the non-volatile memory 122.1 to 122.n and may communicate with the host computer 110 via the I/O interface 115. For example, the controller 121 may receive write operations from the host computer 110 via the I/O interface 115 to store data at the non-volatile memory 122.1 to 122.n and read operations from the host computer 110 to retrieve data from the non-volatile memory 122.1 to 122.n. The controller 121 may further control other such operations for the non-volatile memory 122.1 to 122.n or other components of the solid-state drive 120 such as wear leveling operations or translations between logical and physical addresses. Further details with regard to the solid-state drive120 are described in conjunction with FIG. 6.

In some embodiments, the solid-state drive 120 may be a solid-state drive (SSD) or any other such storage device. The non-volatile memory 122.1 to 122.n may include one or more chips or dies that may individually include one or more types of non-volatile memory devices. In some embodiments, the non-volatile memory devices of the non-volatile memory may be embodied as planar or three-dimensional NAND (“3D NAND”) non-volatile memory devices or NOR. However, in other embodiments, the non-volatile memory may be embodied as any combination of memory devices that use chalcogenide phase change material (e.g., chalcogenide glass), three-dimensional (3D) crosspoint memory, or other types of byte-addressable, write-in-place non-volatile memory, ferroelectric transistor random-access memory (FeTRAM), nanowire-based non-volatile memory, phase change memory (PCM), memory that incorporates memristor technology, Magnetoresistive random-access memory (MRAM), Spin Transfer Torque (STT)-MRAM, silicon-oxide-nitride-oxide-silicon (SONOS) memory, polymer memory such as ferroelectric polymer memory, ovonic memory, nanowire or electrically erasable programmable read-only memory (EEPROM), etc. As previously described, the solid-state drive 120 may be arranged or configured as a solid-state drive. However, examples described in the present disclosure are not limited to storage devices arranged or configured as SSDs.

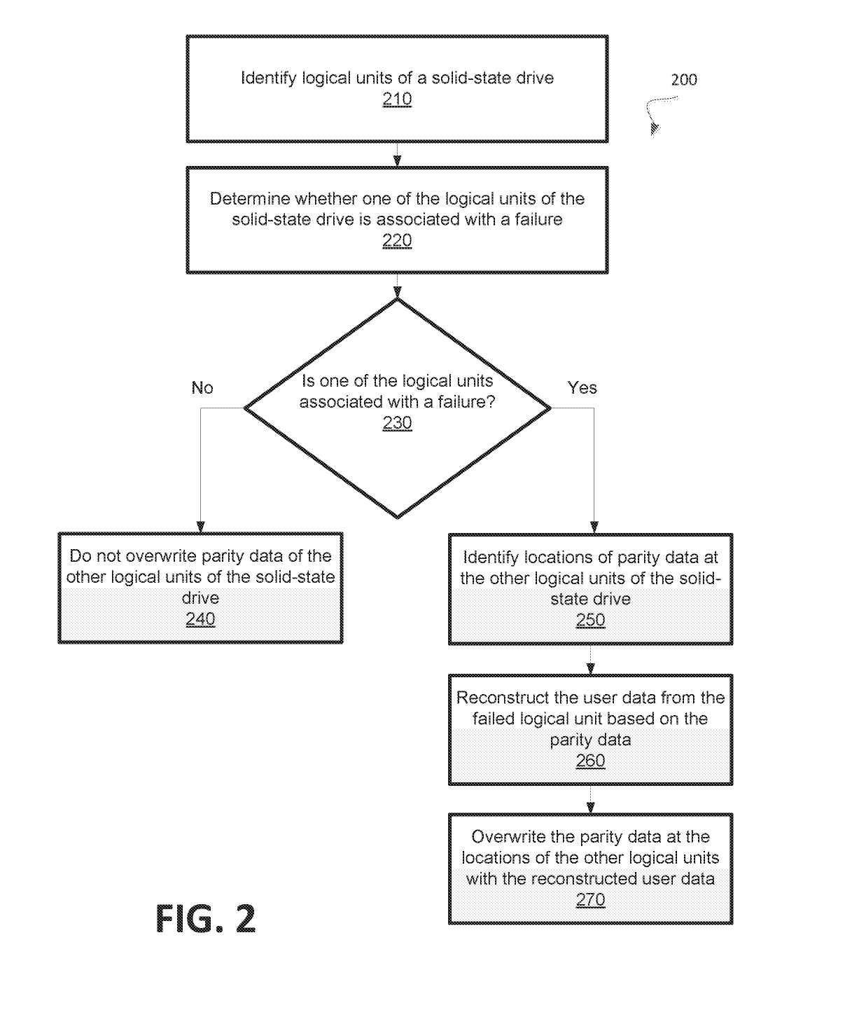

Furthermore, the host computer 110 may include a redundancy controller 124 that provides redundancy for the solid-state drive 120 based on logical units. The redundancy controller 124 may be software, hardware (e.g., a separate integrated circuit), or a combination of software and hardware that is located externally to the solid-state drive 120. The redundancy controller 124 may provide functionality to provide redundancy associated with media failure of the solid-state drive 120 (e.g., failure of the dies of the non-volatile memory 122.1 to 122.n), but may not provide such protection for the failure of the controller 121. Further details with regard to the redundancy controller 124 are described in conjunction with FIGS. 2-5.

FIG. 2 is a flow diagram of an example method 200 to overwrite parity data with reconstructed data of a failed logical unit. In general, the method 200 may be performed by processing logic that may include hardware (e.g., circuitry, dedicated logic, programmable logic, microcode, etc.), software, firmware, or a combination thereof. The redundancy controller 124 of FIG. 1 may perform a portion of or all of the operations of the method 200.

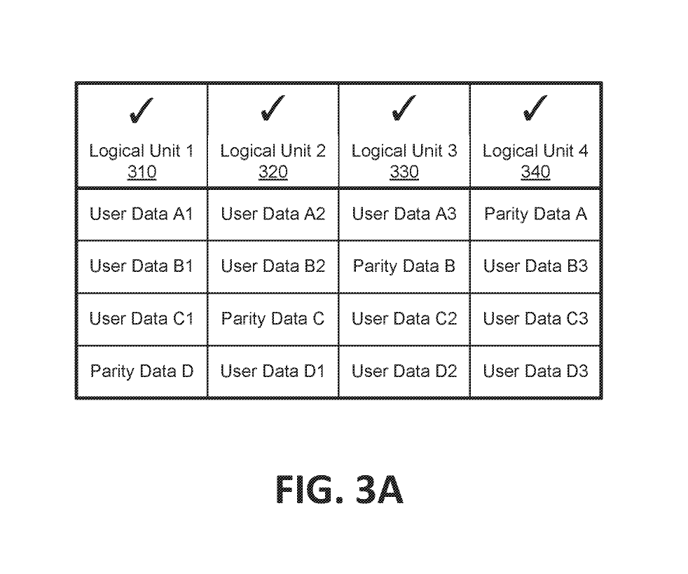

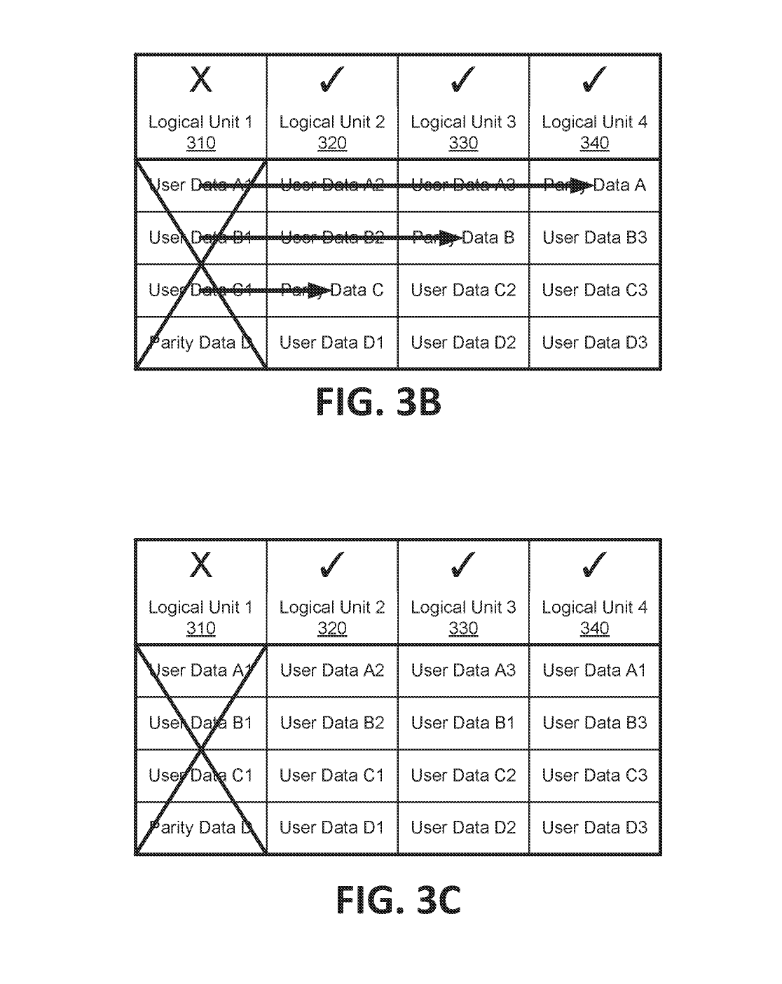

As shown in FIG. 2, the method 200 may begin with the processing identifying four logical units of a solid-state drive (block 210). For example, the solid state drive may include non-volatile memory that is assigned four logical units where user data stored at a particular logical unit is separate from another logical unit (e.g., the user data is not moved or migrated from one logical unit to another logical unit). As such, user data may not be moved between logical units as a result of any wear leveling, defragmentation, or other reliability processes that are performed on the SSD. For example, wear leveling on the SSD may be limited to a single logical unit so that user data may be moved from one location (e.g., a block address) of the logical unit to another location (e.g., another block address) in the logical unit, but not from the logical unit to a location in another logical unit. Each logical unit may store parity data and user data. Further details with regard to a layout of locations, or block addresses, of the logical units are described in conjunction with FIGS. 3A-C and 5.

The processing logic may further determine whether one of the logical units of the solid-state drive has failed (block 220). For example, a logical unit may be identified as having failed when one or more die of the non-volatile memory of an SSD corresponding to the logical unit has failed. The failure of a logical unit may be identified based on one or more factors that include, but are not limited to, a number or rate of error-correcting code based operations needed to recover user data of the failed logical unit, a lack of available space corresponding to the failed logical unit for tolerating any additional failures (e.g., based on portions of the die of the failed logical unit no longer being used to reliably store data), self-test mechanisms that may indicate that the one or more die of the logical unit are no longer reliable, etc. Thus, a logical unit may be considered to be a failed logical unit when the user data at the failed logical unit is no longer reliable or reliably retrieved. If the processing logic determines that one of the logical units of the SSD has not failed, then the processing logic may not overwrite any parity data stored at the other logical units of the solid-state drive (block 240). For example, the parity data stored at the remaining three logical units may still be used to provide die redundancy for an SSD. However, if the processing logic determines that one of the logical units of the solid-state drive has failed, then the processing logic may identify the locations at the other three functioning logical units of the solid-state drive that are storing parity data (block 250). For example, for each block of user data that is stored but no longer retrievable at the failed logical unit, corresponding parity data at another logical unit may be identified. Furthermore, the processing logic may reconstruct (i.e., generate) or receive reconstructed user data of the failed logical unit based on the parity data that is stored at the remaining three functioning logical units (block 260). For example, a combination of the parity data and user data at the remaining functional logical units may generate the reconstructed user data. In some embodiments, the combination may be based on an XOR operation with the parity data and the corresponding user data at the three remaining functional logical units. The XOR operation may correspond to a type of RAID 5 type algorithm or another such RAID type algorithm to reconstruct user data. Subsequently, the reconstructed user data, or the generated user data, of the failed logical unit may replace or overwrite the parity data that was stored at the three remaining functional logical units (block 270). As such, after the failure of a logical unit, the parity data can be overwritten with the reconstructed user data at the other logical units.

In some embodiments, after the overwriting of the parity data with the reconstructed user data, a logical address associated with the user data is updated from the previous physical address corresponding to locations at the failed logical unit of the SSD to the physical address associated with the overwritten parity data of the functional logical unit.

FIG. 3A illustrates an example of four functional logical units of a solid-state drive. In general, the four functional logical units may correspond to logical units identified by the redundancy controller 124 of FIG. 1.

As shown in FIG. 3A, a solid-state drive may include non-volatile memory (e.g., non-volatile memory 122.1 to 122.n such as NAND non-volatile memory, 3D crosspoint non-volatile memory, and MRAM non-volatile memory) that is divided or assigned between four functional logical units. For example, the SSD may be associated with a first logical unit 310, a second logical unit 320, a third logical unit 330, and a fourth logical unit 340. Each of the logical units 310, 320, 330, and 340 may store parity data and user data. As an example, the first logical unit 310 may store user data A1, B1, and Cl, the second logical unit 320 may store user data A2, B2, and D1, the third logical unit 330 may store user data A3, C2, and D2, and the fourth logical unit 340 may store user data B3, C3, and D3. Furthermore, the first logical unit 310 may store parity data D that may be considered the corresponding parity data for D1, D2, and D3 (e.g., a stripe) Similarly, the second logical unit 320 may store parity data C for the user data C1, C2, and C3 (e.g., another stripe), the third logical unit 330 may store parity data B for the user data B1, B2, and B3 (e.g., another stripe), and the fourth logical unit may store parity data A for the user data A1, A2, and A3 (e.g., another stripe). As such, at a first time when each of the logical units of the SSD is functional, each logical unit may store both user data and parity data that may correspond to multiple stripes of various user data. Furthermore, a die of the non-volatile memory (e.g., non-volatile memory 122.1 to 122.n) may not be split across multiple logical units. For example, a single die of the non-volatile memory may not be included as part of more than one logical unit.

FIG. 3B illustrates an example of the overwriting of parity data with reconstructed user data of one failed logical unit of a solid-state drive. In general, the logical units of FIG. 3B may correspond to the logical units of FIG. 3A.

As shown in FIG. 3B, the first logical unit 310 may be identified as having met a condition associated with a failure of a logical unit. For example, a die of the first logical unit 310 may become corrupted or disabled (e.g., as a result of failure of the die) so that the user data or a portion of the user data of the first logical unit 310 is no longer reliable or retrievable. Locations in each of the other logical units that include parity data corresponding to the user data of the failed logical unit 310 may be identified. For example, a first parity data location in the logical unit 340 that corresponds to the user data A1 may be identified along with a second parity data location of the logical unit 330, and a third parity data location in the logical unit 320.

FIG. 3C illustrates an example of the overwriting of parity data with reconstructed user data of one failed logical unit of a solid-state drive. In general, the logical units of FIG. 3C correspond to the logical units of FIG. 3B after the overwriting of parity data of logical units of the solid-state drive.

As shown in FIG. 3C, the first logical unit 310 may be identified as being a failed logical unit while the second logical unit 320, third logical unit 330, and fourth logical unit 340 may still be functional or operational (e.g., not associated with a failure) logic units. Since the first logical unit 310 has failed, the user data A1, B1, and C1 stored at the first logical unit 310 may no longer be reliably retrievable. As such, the user data A1, B1, and C1 may be reconstructed based on the parity data B, C, and D. For example, a combination of the parity data A with the user data A2 and A3 may be used to reconstruct the user data Al that has become irretrievable. The combination may be based on an XOR operation. For example, an XOR operation between the parity data A, user data A1, and user data A2 may generate the user data A1. Similarly, the parity data B may be used to reconstruct the user data B1 and the parity data C may be used to reconstruct the user data C1. After the user data A1, B1, and C1 have been reconstructed based on the parity data A at the fourth logical unit 340, the parity data B at the third logical unit 330, and the parity data C at the second logical unit 320, the reconstructed user data A1, B1, and C1 may be stored over the parity data A, parity data B, and parity data C at the respective logical units 320, 330, and 340. Thus, after the failure of the logical unit 310, the reconstructed user data may overwrite the parity data at the remaining functional logical units.

As such, at a first time, four functional logical units may store user data and corresponding parity data. At a subsequent time, one of the functional logical units may no longer be identified as functioning. In response to such an identification, the user data at the failed logical unit may be reconstructed and replace the parity data stored at the remaining logical units. For example, the reconstructed user data may be generated based on parity data stored at another logical unit and additional user data that is stored at an additional block address or additional location of an additional logical unit. Thus, the reconstructed user data may be based on a combination of parity data from one of the logical units and user data from the other logical units. No parity data may be stored at the remaining logical units once the reconstructed data has been stored in response to the failure of one of the logical units.

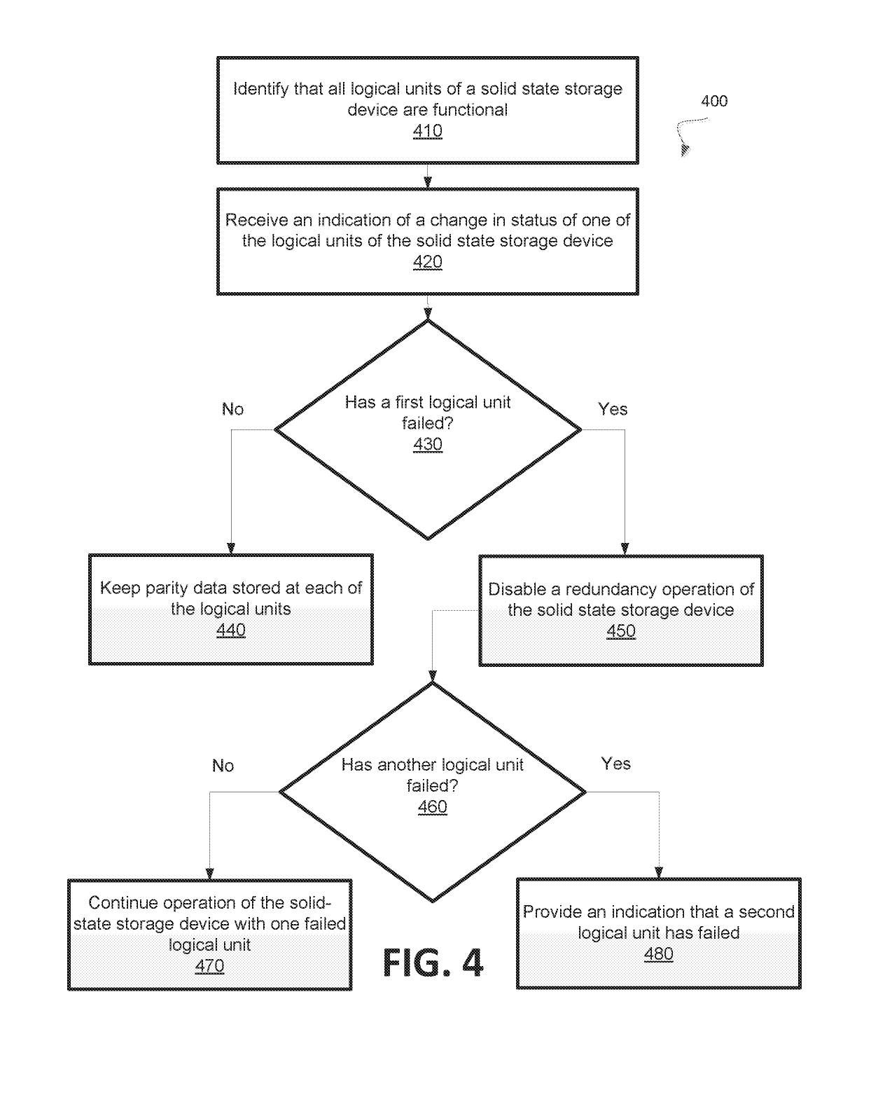

FIG. 4 is a flow diagram of a method to disable die redundancy or to generate a notification of a failed solid-state drive based on a number of failed logical units. In general, the method 400 may be performed by processing logic that may include hardware (e.g., circuitry, dedicated logic, programmable logic, microcode, etc.), software, firmware, or a combination thereof. In some embodiments, the redundancy controller 124 of FIG. 1 may perform a portion of or all of the operations of the method 400.

As shown in FIG. 4, the method 400 may begin with processing logic identifying four functional logical units of a solid-state drive (block 410). For example, a determination may be made that no logical unit of the solid-state drive is associated with a failure. In some embodiments, the identifying of the four functional logical units may be in response to an initialization or formatting of the solid-state drive. Thus, the die redundancy operation described herein may be applied before user data is written to the solid-state drive. The processing logic may subsequently receive an indication of a change in status of one of the logical units of the solid-state drive (block 420). In response to the indication, the processing logic may subsequently determine whether one of the four logical units has failed (block 430). For example, the processing logic may receive information associated with an error rate or a testing of a die that indicates that a logical unit is unreliable. The error rate or the testing may indicate a rate at which data retrieved from the logical unit is unreliable. For example, if the error rate exceeds a threshold percentage of operations needing an error code correction (e.g., to reconstruct the originally stored data), then the logical unit may be considered to be a failed logical unit. If the processing logic determines that one of the logical units has not yet failed, then the processing logic may keep parity data stored at each of the logical units (block 440). For example, the logical units of the solid-state drive may continue to store parity data for corresponding user data stored at respective logical units. Thus, die redundancy functionality of the solid-state drive may be retained. However, if the processing logic determines that one of the logical units has failed, then the processing logic may disable a die redundancy functionality or operation of the solid-state drive (block 450). For example, the user data of the failed logical unit may be reconstructed and may be allowed to overwrite the parity data stored at the other functional logical units. As such, since no parity is now stored at the logical units, a die redundancy operation may no longer be provided. In some embodiments, after the die redundancy functionality has been disabled, a notification may be provided regarding the disabling of the die redundancy functionality of the SSD. For example, the notification may be provided by software or hardware that implements the die redundancy implementation that provided the distribution of the user data and parity data over the logical units of the SSD to provide the die redundancy of the SSD.

Referring to FIG. 4, the processing logic may further determine whether a second logical unit of the four logical units has failed (block 460). For example, at a later time, another die (e.g., of the non-volatile memory) malfunction or failure corresponding to another logical unit may be identified. If the processing logic determines that a second logical unit has not yet failed, then the processing logic may continue the operation of the solid-state drive with the three remaining functional logic units (block 470). For example, user data may continue to be stored at the logical units. However, if the processing logic determines that the second logical unit has failed, then the processing logic may provide an indication that the second logical unit has failed (block 480). In some embodiments, the indication may indicate that the solid-state drive is no longer reliable after two of the logical units have failed. Furthermore, the indication may be a notification that may be provided by the software or hardware that is external to the SSD and that implements the die redundancy implementation to a user of a computer system using the solid-state drive.

As such, a first logical unit failure may not be reported to a user of a computer system that uses an SSD. The SSD may be associated with a lower reliability specification so that the failure of one logical unit is expected during the lifetime operation of the SSD and is mitigated by the die redundancy associated with overwriting parity data with reconstructed user data as previously described. However, in an embodiment with 4 logical units, if a second logical unit fails so that half of the logical units of the SSD are no longer functional, then the user of the computer system may receive a notification or a status message to inform the user of the unreliability or failure of the SSD. In some embodiments, the non-volatile memory of the SSD may be associated with another number of logical units. For example, the non-volatile memory of the SSD may correspond to fewer logical units (e.g., three) or more than four logical units (e.g., sixteen logical units).

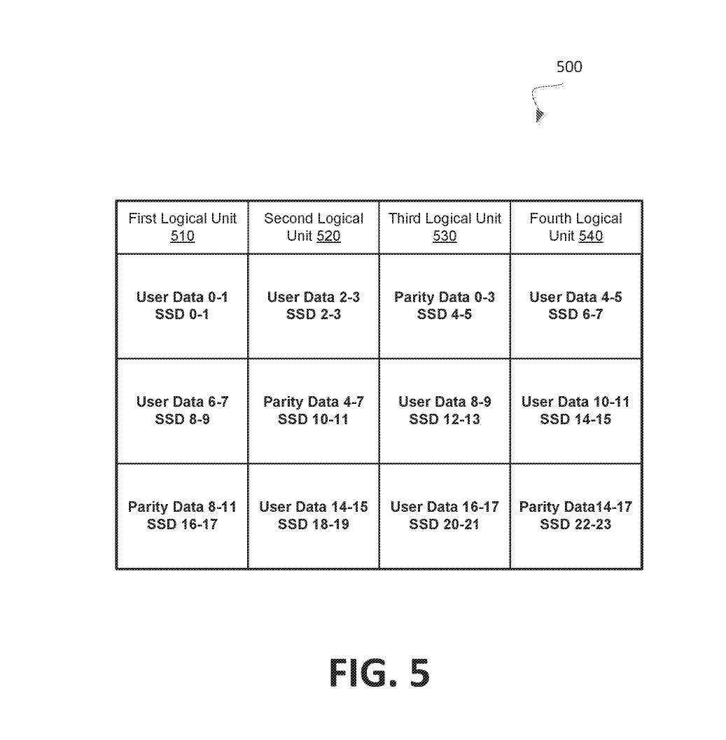

FIG. 5 illustrates an example table 500 with a layout of user data and parity data stored in logical units of a solid-state drive. In general, the table 500 may correspond to logical units of a solid-state drive 120 that are identified by the redundancy controller 124 of FIG. 1.

As shown in FIG. 5, the table 500 may illustrate the layout of user data and parity data with corresponding block addresses of the solid-state drive. For example, the block addresses, or locations, 0-1, 8-9, and 16-17 of the solid-state drive may be included as part of the first logical unit 510 while block addresses 2-3, 10-11, and 18-19 may be included as part of the separate second logical unit 520. The third and fourth logical units 530 and 540 may likewise include particular block addresses of the solid-state drive. The solid-state drive may include a ratio of two user data blocks to each parity data blocks. For example, as shown, the first logical includes two user data blocks (e.g., 0-1 and 6-7 at solid-state drive block addresses 0-1 and 8-9) for one parity data block (e.g., parity data 8-11 at solid-state drive block addresses 16-17). However, any combination of user data blocks and parity data blocks may be used. Thus, the non-volatile memory of a solid-state drive may include multiple logical units where each logical unit corresponds to a separation portion of locations or block addresses.

In some embodiments, the performance of a solid-state drive management process, such as wear leveling, defragmentation, or other such processes may involve the moving of user data within a single logical unit. For example, a wear leveling process performed on the SSD may involve the moving of user data of the first logical unit of non-volatile memory from a location within the first logical unit to another location within the same first logical unit based on a number of write operations or erase cycles that have been performed on each of the blocks of the logical unit. For example, if the block with a block address of 0 of the first logical unit 510 has exceeded a threshold amount of erase cycles, then the user data at the block address of 0 may be moved or copied to the block address of 8 that is also included within the same logical unit as opposed to being moved or copied to another block address that is in a different logical unit Similarly, a defragmentation may move user data to different block addresses within the same logic unit as opposed to moving data from one logical unit to another logical unit during the defragmentation operation. Thus, when the defragmentation operation physically organizes the user data stored at the block addresses of a logical unit based on organizing the user data into a smaller number of regions, the user data may only change to another block address within the same logical unit as opposed to another block address of another logical unit.

After the first logical unit 510 is determined to be a failed logical unit, then the user data blocks at the solid-state drive addresses 0-1 and 8-9 may be reconstructed using parity data at the other logical units 520, 530, and 540 and may be written to the location currently storing the parity data at the other logical units. Furthermore, a re-mapping may be performed so that a pointer to the user data is changed from a solid-state drive block address for the first logical unit 510 to a solid-state drive block address of a new logical unit. For example, before the failure of the first logical unit 510, user data may be stored at the solid-state drive block address 0 of the first logical unit 510 and a pointer for the user data may point to the solid-state drive block address 0. For example, the pointer may identify the block address. Thus, an application of a host computer may access a logical address corresponding to the pointer to the block address 0 to access the user data. After the failure of the first logical unit 510, the user data at the solid-state drive block address 0 may be reconstructed and written to the parity data block 0 that is stored at the solid-state drive block address 4. In response to such a write operation, the pointer for the user data may be updated or changed from pointing to the solid-state drive block address 0 in the first logical unit to the solid-state drive block address 4 in the third logical unit 530. For example, the pointer for the logical address may be changed to point to the block address 4. Thus, when the application subsequently requests the user data corresponding to the same logical address, the changed or updated pointer may be used to retrieve the user data at the block address of 4 instead of the block address of 0.

Although a particular layout of user data and parity data is illustrated in the table 500, any combination or layout of user data and parity data with respect to the solid-state drive and logical units may be used.

FIG. 6 is a block diagram of an example computer system associated with a solid-state drive.

As shown in FIG. 6, the computer system includes a host computer 1604 communicably coupled to a solid-state drive 602 by an I/O interface 605 or bus (e.g., via the I/O interface 115). For example, the host computer 104 may employ the system bus 105 for transferring digital information, such as data, computer-executable instructions, applications, write operations, read operations, etc., between the host computer 604 and the solid-state drive 602. The host computer 104 may also implement the redundancy controller 124. For example, the host computer 104 may implement or include processing logic that may be firmware, software, discrete logic, or an application specific integrated circuit (ASIC) or a combination thereof to implement the redundancy controller 124. The solid-state drive 602 may include a solid-state drive controller 606 (e.g., an SSD controller) and a plurality of non-volatile memory packages 108.1-108.n (e.g., NAND flash packages, 3D crosspoint non-volatile memory packages, and MRAM non-volatile memory packages). The solid-state drive controller 606 may include a controller 610 communicably coupled to the I/O interface 605, a memory buffer 612, a processing device 614, control logic circuitry 616, a memory arbiter 620, and a plurality of channels 622.1-622.n communicably coupled between the memory arbiter 620 and the non-volatile memory packages 608.1-608.n, respectively.

The memory buffer 612 may be implemented using a volatile static random access memory (SRAM), or any other volatile memory, for at least temporarily storing digital information (e.g., the data, computer-executable instructions, applications, etc.) as well as context information for the solid-state drive 602. Further, the processing device 614 may be configured to execute at least one program out of at least one memory to allow the memory arbiter 620 to direct the information from the memory buffer 612 to the solid-state memory within the non-volatile memory packages 608.1-608.n via the channels 622.1-622.n. Furthermore, via the I/O interface 605, the controller 610 may receive commands issued by the host computer 604 for writing or reading the data to and from the solid-state memory within the non-volatile memory packages 608.1-608.n.

The non-volatile memory packages 608.1-608.n may each include one or more non-volatile memory dies, in which each non-volatile memory die may include non-volatile memory (e.g., NAND flash memory) configured to store digital information or data in one or more arrays of memory cells organized into one or more pages. For example, the non-volatile memory package 608.1 may include one or more non-volatile memory dies. Each of the one or more non-volatile memory dies may be used or assigned to one logical unit so that block addresses of one logical unit are not distributed between two or more logical units.

FIG. 7 is a block diagram of an example machine of a computer system 700 that is associated with a solid-state drive. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), etc.) a static memory 706 (e.g., flash memory, static random access memory (SRAM), etc.), and a data storage device 718, which communicate with each other via a bus 730. The data storage device 718 may correspond to the solid-state drive 120 of FIG. 1. In some embodiments, any or all of the main memory 704, static memory 706, and data storage device 718 may be implemented as part of the solid-state drive 120.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing operations and steps discussed herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In one implementation, the instructions 726 include instructions to implement functionality corresponding to redundancy controller (e.g., redundancy controller 124 of FIG. 1). While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

The following examples pertain to further embodiments.

Example 1 is a system comprising an interface operatively coupled to a solid-state drive and a processing device, coupled to the solid-state drive via the interface, to receive an indication of a failure of a logical unit of a non-volatile memory of the solid-state drive, identify, response to the indication of the failure, parity data at locations of other logical units of the non-volatile memory of the solid-state drive, reconstruct user data from the logical unit based on the parity data from the locations of the other logical units of the non-volatile memory of the solid-state drive, and store the reconstructed user data from the logical unit at the locations of the other logical units that store the parity data.

In Example 2, in the system of Example 1, to reconstruct the user data from the logical unit, the processing device is further to generate at least a portion of the reconstructed user data based on a combination of one of the parity data from one of the locations of the other logical units and user data from an additional location of an additional logical unit.

In Example 3, in the system of any of Examples 1-2, to store the reconstructed data at the locations of the other logical units that store the parity data, the processing device is further to overwrite the parity data at the locations of the other logical units with the reconstructed user data, wherein the parity data is no longer stored after the overwriting of the parity data with the reconstructed user data.

In Example 4, in the system of any of Examples 1-3, the processing device is further to provide, in response to the indication of the failure of the logical unit, a notification of a disabling of a die redundancy operation of the solid-state drive.

In Example 5, in the system of any of Examples 1-4, the processing device is further to receive, after receiving the indication of the failure of the logical unit, another indication of a failure of a second logical unit of the non-volatile memory of the solid-state drive and to provide, in response to receiving the another indication of the failure of the second logical unit, an indication of a failure of the solid-state drive.

In Example 6, in the system of any of Examples 1-5, the processing device is further to receive a request to perform a wear leveling operation or a defragmentation operation for the non-volatile memory in response to the request, move data between block addresses of the non-volatile memory that are included in a single logical unit.

In Example 7, in the system of any of Examples 1-6, the logical unit stores a first user data corresponding to a first stripe associated with the non-volatile memory and a second user data corresponding to a second stripe associated with the non-volatile memory, wherein to reconstruct the user data, the processing device is further to identify a location of a first parity data for the first stripe stored at a first functional logical unit of the other logical units and identify a location of a second parity data for the second stripe stored at a second functional logical unit of the other logical units, reconstruct the first user data based on a combination of the first parity data stored at the first functional logical unit and first user data of the first stripe stored at the second functional logical unit, and reconstruct the second user data based on a combination of the second parity data stored at the first functional logical unit and second user data of the second stripe stored at the first functional logical unit.

In Example 8, in the system of any of Examples 1-7, wherein to store the reconstructed data at the locations of the other logical units that store the parity data, the processing device is further to overwrite the first parity data of the first stripe that is stored at the first functional logical unit with the reconstructed first user data overwrite the second parity data of the second stripe that is stored at the second functional logical unit with the reconstructed second user data.

In Example 9, in the system of any of Examples 1-8, the failure of the logical unit is based on a failure of a die of the non-volatile memory.

In Example 10, in the system of any of Examples 1-9, the reconstructing of the user data is based on an exclusive-or (XOR) operation using the parity data.

In Example 11, an apparatus comprises a redundancy controller that is external to a solid state drive (SSD). The redundancy controller is to identify a plurality of logical units associated with a plurality of non-volatile memory devices of the SSD where the plurality of non-volatile memory devices are associated with a plurality of block addresses of the SSD and where each of the plurality of logical units corresponds to a separate portion of the plurality of block addresses associated with the plurality of non-volatile memory devices. The redundancy controller is further to determine whether a first logical unit of the plurality of logical units is associated with a failure, identify, in response to determining that the first logical unit is associated with the failure, parity data at a block address of a second logical unit of the plurality of logical units, generate user data corresponding to one of the block addresses of the first logical unit based on the parity data at the block address of the second logical unit, and store the generated user data at the block address of the second logical unit.

In Example 12, in the apparatus of Example 11, to generate the user data corresponding to the one of the block addresses of the first logical unit, the redundancy controller is further to identify a block address of a third logical unit of the plurality of logical units that stores user data that corresponds to the parity data at the block address of the second logical unit where the generating of the user data corresponding to one of the block addresses of the first logical unit is further based on the user data of the block address of the third logical unit.

In Example 13, in the apparatus of any of Examples 11-12, to store the generated user data at the block address of the second logical unit, the redundancy controller is further to overwrite the parity data at the block address of the second logical unit with the generated user data where the parity data is no longer stored after the overwriting of the parity data with the generated user data.

In Example 14, in the apparatus of any of Examples 11-13, the redundancy controller is further to determine that another logical unit of the plurality of logical units is associated with a failure after determining that the first logical unit is associated with the failure and provide, in response to determining that the another logical unit is associated with the failure, an indication of a failure of the SSD.

In Example 15, in the apparatus of any of Examples 11-14, the failure associated with the first logical unit is based on a failure of a die of the non-volatile memory devices of the SSD.

In Example 16, in the apparatus of any of Examples 11-15, the generating of the user data is based on an exclusive-or (XOR) operation between the parity data at the block address of the second logical unit and additional user data stored at an additional block address of a third logical unit of the plurality of logical units.

In Example 17, a method comprises receiving an indication of a failure of a logical unit of a non-volatile memory of a solid-state drive, in response to the indication of the failure, identifying parity data at locations of other logical units of a non-volatile memory of the solid-state drive, reconstructing user data from the logical unit based on the parity data from the locations of the other logical units of the non-volatile memory of the solid-state drive, and storing, by a processing device, the reconstructed user data from the logical unit at the locations of the other logical units that store the parity data.

In Example 18, in the method of Example 17, the reconstructing of the user data from the logical unit comprises generating at least a portion of the reconstructed user data based on a combination of one of the parity data from one of the locations of the other logical units and user data from an additional location of an additional logical unit.

In Example 19, in the method of any of Examples 17-18, storing the reconstructed user data at the locations of the other logical units that store the parity data comprises overwriting the parity data at the locations of the other logical units with the reconstructed data, wherein the parity data is no longer stored after the overwriting of the parity data with the reconstructed user data.

In Example 20, in the method of any of Examples 17-19, the method further comprises in response to the indication of the failure of the logical unit, providing a notification of a disabling of a die redundancy operation of the solid-state drive.

In Example 21, in the method of any of Examples 17-20, the method further comprises receiving, after receiving the indication of the failure of the logical unit, another indication of a failure of a second logical unit of the non-volatile memory of the solid-state drive and in response to receiving the another indication of the failure of the second logical unit, providing an indication of a failure of the solid-state drive.

In Example 22, in the method of any of Examples 17-21, the logical unit stores a first user data corresponding to a first stripe associated with the non-volatile memory and a second user data corresponding to a second stripe associated with the non-volatile memory, wherein the reconstructing of the user data comprises identifying a location of a first parity data for the first stripe stored at a first functional logical unit of the other logical units and identify a location of a second parity data for the second stripe stored at a second functional logical unit of the other logical units, reconstructing the first user data based on a combination of the first parity data stored at the first functional logical unit and first user data of the first stripe stored at the second functional logical unit, and reconstructing the second user data based on a combination of the second parity data stored at the first functional logical unit and second user data of the second stripe stored at the first functional logical unit.

In Example 23, in the method of any of Examples 17-22, storing the reconstructed data at the locations of the other logical units that store the parity data comprises overwriting the first parity data of the first stripe that is stored at the first functional logical unit with the reconstructed first user data and overwriting the second parity data of the second stripe that is stored at the second functional logical unit with the reconstructed second user data.

In Example 24, in the method of any of Examples 17-23, the reconstructing of the user data is based on an exclusive-or (XOR) operation using the parity data.

In Example 25, a system comprising a system on a chip (SOC) comprises a plurality of functional units and a redundancy controller, coupled to the functional units, to receive an indication of a failure of a logical unit of a non-volatile memory of the solid-state drive, in response to the indication of the failure, identify parity data at locations of other logical units of the non-volatile memory of the solid-state drive, reconstruct user data from the logical unit based on the parity data from the locations of the other logical units of the non-volatile memory of the solid-state drive and store the reconstructed user data from the logical unit at the locations of the other logical units that store the parity data.

In Example 26, the SOC of Example 25 further comprises the subject matter of Examples 2-10.

In Example 27, in the SOC of Example 25, the redundancy controller is further operable to perform the subject matter of Examples 17-24.

In Example 28, the SOC of Example 25 further comprises the subject matter of Examples 11-16.

Example 29 is an apparatus comprises a means for receiving an indication of a failure of a logical unit of a non-volatile memory of the solid-state drive, means for identifying, in response to the indication of the failure, parity data at locations of other logical units of the non-volatile memory of the solid-state drive, means for reconstructing user data from the logical unit based on the parity data from the locations of the other logical units of the storage memory of the solid-state drive, and means for storing the reconstructed user data from the logical unit at the locations of the other logical units that store the parity data.

In Example 30, the apparatus of Example 29 further comprises the subject matter of any of Examples 1-10 and 11-16.

Example 31 is an apparatus comprising a memory and a processor coupled to the memory and comprising a redundancy controller that is configured to perform the method of any of Examples 17-24.

In Example 32, the apparatus of Example 31 further comprises the subject matter of any of Examples 1-16.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure.

What is claimed is:

1. A system comprising:
an interface operatively coupled to a solid-state drive; and
a processing device, coupled to the solid-state drive via the interface, to:
receive an indication of a failure of a logical unit of a non-volatile memory of the solid-state drive;
in response to the indication of the failure, identify parity data at locations of other logical units of the non-volatile memory of the solid-state drive;
reconstruct user data from the logical unit based on the parity data from the locations of the other logical units of the non-volatile memory of the solid-state drive; and
store the reconstructed user data from the logical unit at the locations of the other logical units that store the parity data.

2. The system of claim 1, wherein to reconstruct the user data from the logical unit, the processing device is further to:
generate at least a portion of the reconstructed user data based on a combination of one of the parity data from one of the locations of the other logical units and user data from an additional location of an additional logical unit.

3. The system of claim 1, wherein to store the reconstructed data at the locations of the other logical units that store the parity data, the processing device is further to:
overwrite the parity data at the locations of the other logical units with the reconstructed user data, wherein the parity data is no longer stored after the overwriting of the parity data with the reconstructed user data.

4. The system of claim 1, wherein the processing device is further to:
in response to the indication of the failure of the logical unit, provide a notification of a disabling of a die redundancy operation of the solid-state drive.

5. The system of claim 1, wherein the processing device is further to:
receive, after receiving the indication of the failure of the logical unit, another indication of a failure of a second logical unit of the non-volatile memory of the solid-state drive; and
in response to receiving the another indication of the failure of the second logical unit, provide an indication of a failure of the solid-state drive.

6. The system of claim 1, wherein the processing device is further to:
receive a request to perform a wear leveling operation or a defragmentation operation for the non-volatile memory; and
in response to the request, move data between block addresses of the non-volatile memory that are included in a single logical unit.

7. The system of claim 1, wherein the logical unit stores a first user data corresponding to a first stripe associated with the non-volatile memory and a second user data corresponding to a second stripe associated with the non-volatile memory, wherein to reconstruct the user data, the processing device is further to:
identify a location of a first parity data for the first stripe stored at a first functional logical unit of the other logical units and identify a location of a second parity data for the second stripe stored at a second functional logical unit of the other logical units;
reconstruct the first user data based on a combination of the first parity data stored at the first functional logical unit and first user data of the first stripe stored at the second functional logical unit; and
reconstruct the second user data based on a combination of the second parity data stored at the first functional logical unit and second user data of the second stripe stored at the first functional logical unit.

8. The system of claim 7, wherein to store the reconstructed data at the locations of the other logical units that store the parity data, the processing device is further to:
overwrite the first parity data of the first stripe that is stored at the first functional logical unit with the reconstructed first user data; and
overwrite the second parity data of the second stripe that is stored at the second functional logical unit with the reconstructed second user data.

9. The system of claim 1, wherein the failure of the logical unit is based on a failure of a die of the non-volatile memory.

10. The system of claim 1, wherein the reconstructing of the user data is based on an exclusive-or (XOR) operation using the parity data.

11. An apparatus comprising:
a redundancy controller, external to a solid state drive (SSD), to:
identify a plurality of logical units associated with a plurality of non-volatile memory devices of the SSD, wherein the plurality of non-volatile memory devices are associated with a plurality of block addresses of the SSD, wherein each of the plurality of logical units corresponds to a separate portion of the plurality of block addresses associated with the plurality of non-volatile memory devices;
determine whether a first logical unit of the plurality of logical units is associated with a failure;
in response to determining that the first logical unit is associated with the failure, identify parity data at a block address of a second logical unit of the plurality of logical units;
generate user data corresponding to one of the block addresses of the first logical unit based on the parity data at the block address of the second logical unit; and
store the generated user data at the block address of the second logical unit.

12. The apparatus of claim 11, wherein to generate the user data corresponding to the one of the block addresses of the first logical unit, the redundancy controller is further to:
identify a block address of a third logical unit of the plurality of logical units that stores user data that corresponds to the parity data at the block address of the second logical unit, wherein the generating of the user data corresponding to one of the block addresses of the first logical unit is further based on the user data of the block address of the third logical unit.

13. The apparatus of claim 11, wherein to store the generated user data at the block address of the second logical unit, the redundancy controller is further to:
overwrite the parity data at the block address of the second logical unit with the generated user data, wherein the parity data is no longer stored after the overwriting of the parity data with the generated user data.

14. The apparatus of claim 11, wherein the redundancy controller is further to:
determine that another logical unit of the plurality of logical units is associated with a failure after determining that the first logical unit is associated with the failure; and
in response to determining that the another logical unit is associated with the failure, provide an indication of a failure of the SSD.

15. The apparatus of claim 11, wherein the failure associated with the first logical unit is based on a failure of a die of the non-volatile memory devices of the SSD.

16. The apparatus of claim 11, wherein the generating of the user data is based on an exclusive-or (XOR) operation between the parity data at the block address of the second logical unit and additional user data stored at an additional block address of a third logical unit of the plurality of logical units.

17. A method comprising:
receiving an indication of a failure of a logical unit of a non-volatile memory of a solid-state drive;
in response to the indication of the failure, identifying parity data at locations of other logical units of the non-volatile memory of the solid-state drive;
reconstructing user data from the logical unit based on the parity data from the locations of the other logical units of the non-volatile memory of the solid-state drive; and
storing, by a processing device, the reconstructed user data from the logical unit at the locations of the other logical units that store the parity data.

18. The method of claim 17, wherein the reconstructing of the user data from the logical unit comprises:
generating at least a portion of the reconstructed user data based on a combination of one of the parity data from one of the locations of the other logical units and user data from an additional location of an additional logical unit.

19. The method of claim 17, wherein storing the reconstructed user data at the locations of the other logical units that store the parity data comprises:
overwriting the parity data at the locations of the other logical units with the reconstructed data, wherein the parity data is no longer stored after the overwriting of the parity data with the reconstructed user data.

20. The method of claim 17, further comprising:
in response to the indication of the failure of the logical unit, providing a notification of a disabling of a die redundancy operation of the solid-state drive.

21. The method of claim 17, further comprising:
receiving, after receiving the indication of the failure of the logical unit, another indication of a failure of a second logical unit of the non-volatile memory of the solid-state drive; and
in response to receiving the another indication of the failure of the second logical unit, providing an indication of a failure of the solid-state drive.

22. The method of claim 17, wherein the logical unit stores a first user data corresponding to a first stripe associated with the non-volatile memory and a second user data corresponding to a second stripe associated with the non-volatile memory, wherein the reconstructing of the user data comprises:
identifying a location of a first parity data for the first stripe stored at a first functional logical unit of the other logical units and identify a location of a second parity data for the second stripe stored at a second functional logical unit of the other logical units;
reconstructing the first user data based on a combination of the first parity data stored at the first functional logical unit and first user data of the first stripe stored at the second functional logical unit; and
reconstructing the second user data based on a combination of the second parity data stored at the first functional logical unit and second user data of the second stripe stored at the first functional logical unit.

23. The method of claim 22, wherein storing the reconstructed data at the locations of the other logical units that store the parity data comprises:
overwriting the first parity data of the first stripe that is stored at the first functional logical unit with the reconstructed first user data; and
overwriting the second parity data of the second stripe that is stored at the second functional logical unit with the reconstructed second user data.

24. The method of claim 17, wherein the reconstructing of the user data is based on an exclusive-or (XOR) operation using the parity data.
